(19) United States
(12) Patent Application Publication
(10) Pub. No.: US 2012/0219423 A1
(43) Pub. Date: Aug. 30, 2012

(54) Wind Turbine Rotor Blade with Varying Blade Depth

(76) Inventor: Gunter Fischer, Hamburg (DE)

(21) Appl. No.: 13/359,908

(22) Filed: Jan. 27, 2012

(30) Foreign Application Priority Data
Feb. 25, 2011 (EP) 11 001 581.5

(51) Int. Cl. F03D 1/06

(52) U.S. Cl. 416/223 R

(57) ABSTRACT

A wind turbine rotor blade has a blade root, a blade tip and a blade depth varying over the length of the rotor blade. The rotor blade has a maximum blade depth at a longitudinal position between the blade root and the blade tip. The blade depth in an outer longitudinal section, which extends over a length of 20% or more of the blade length, lies in a range from 20% to 30% of the maximum blade depth.

### CROSS REFERENCE TO RELATED APPLICATION

This application claims priority of European patent application no. 11 001 581.5, filed Feb. 25, 2011, the entire content of which is incorporated herein by reference.

### FIELD OF THE INVENTION

The invention relates to a wind turbine rotor blade having a blade root, a blade tip and a blade depth varying along the length of the rotor blade. The blade depth reaches a maximum depth at a longitudinal position between the blade root and the blade tip.

### BACKGROUND OF THE INVENTION

The power captured by the rotor of a wind turbine from the wind depends on the aerodynamic characteristics of the rotor blades. Among other things, the aerodynamic profile, the angle of attack, the relative blade thickness and the blade depth of the rotor blade are important. A theoretically optimal blade depth profile can be found based on Betz's law and a series of simplifying assumptions. In this way one arrives at the following relationship for the optimal local blade depth:

$${t}_{opt} = \frac{2 π}{z} \frac{8}{9 {c}_{A}} \frac{{v}_{WA}}{λ {v}_{r} * r}$$

where:
tₒₚₜ=optimal local blade depth (m)
v_{WA}=design wind speed (m/s)
u=peripheral speed (ms/s)
vᵣ=\sqrt{v_{w}²+u²} local resultant approach velocity (m/s)
v_{w}=wind speed (m/s)
λ=local tip speed ratio (−)
c_{A}=local lift coefficient (−)
r=local blade radius (m)
z=number of rotor blades (−)

The 1/r dependency of the optimal blade depth, according to which the blade depth increases from outside to inside and is infinite at the hub, can be seen. Such a profile is not possible in practice, but represents a starting point for the development of rotor blades. Furthermore, strength requirements and complex structural considerations must be incorporated. As a result, conventional rotor blades usually have a blade depth which initially increases from the blade root towards the blade tip, reaches a maximum blade depth at a longitudinal position between the blade root and the blade tip, and decreases from there to the blade tip approximately linearly or with a slightly hyperbolic or concave profile.

A rotor blade, which has a relatively low strength, that is, a low blade depth, is known from United States patent application publication 2008/0206055. As is apparent from the examples described in the publication and the strengths required at different radius positions, the relative profile of the blade depth is not significantly different from other known rotor blades.

### SUMMARY OF THE INVENTION

On this basis, it is the object of the invention to provide a wind turbine rotor blade with a blade root, a blade tip and a blade depth varying along the length of the rotor blade, which achieves a maximum blade depth at a longitudinal position between the blade root and the blade tip, which features an improved compromise between the mechanical stresses occurring during operation and the power captured from the wind.

The wind turbine rotor blade of the invention includes: a blade root; a blade tip; the rotor blade having a blade length and a blade depth which varies over the length thereof; the blade depth reaching a maximum blade depth at a longitudinal position along the length between the root and the tip; an outer longitudinal section extending over 20% or more of the blade length; and, the rotor blade having a blade depth in the outer longitudinal section which lies in a range of 20% to 30% of the maximum blade depth.

The wind turbine rotor blade comprises a blade root, a blade tip and a blade depth varying over the length of the rotor blade, which achieves a maximum blade depth at a longitudinal position between the blade root and the blade tip, wherein the blade depth in an outer longitudinal section, which extends over a length of 20% or more of the blade length, lies between 20% and 30% of the maximum blade depth. In other words, the wind turbine rotor blade according to the invention comprises an outer longitudinal section, in which the blade depth varies less markedly in comparison with conventional rotor blades or remains approximately constant. The blade depth thus deviates more strongly than usual in the outer longitudinal section from the theoretically optimal profile. In addition, the blade depth in the entire outer longitudinal section is relatively low compared to conventional blades.

The feature that the longitudinal section is an outer longitudinal section means that the longitudinal section is at a distance from the blade root that is radially relatively far outside relative to a rotor axis. The distance of the outer longitudinal section to the blade root can, for example, be 30% or more, 40% or more, 50% or more, 60% or more or 70% or more of the blade length. There can also be a distance between the outer longitudinal section and the blade tip.

The maximum blade depth can lie at a single, defined longitudinal position, from which the blade depth decreases in both directions. The maximum blade depth can, however, also exist over a defined longitudinal section in which the blade depth remains constant. The blade length always means the total length of the rotor blade from the blade root to the blade tip.

Calculations have shown that lower mechanical stresses occur as a result of the outer longitudinal section being constructed in accordance with the invention, in particular in the case of extreme gusts, since the load distribution is displaced inwards. Therefore, the blade length can be increased without causing greater overall mechanical stress, which more than offsets the potential loss of performance caused by the blade depth profile deviating from the optimum profile. On the whole, as a result of the configuration of the outer longitudinal section according to the invention, rotor blades of the same length can be provided, which exert lower mechanical stresses or which enable a greater power input for the same mechanical stresses while using a longer blade length. Furthermore, the dynamic loads during operation are reduced by the aforementioned embodiment, because the center of mass is displaced towards the blade root. This reduces the operating loads for dimensioning the blade connection.

Another advantage is that because of the lower blade depth in the outer longitudinal section there are buckling fields that are smaller than those of a conventionally shaped rotor blade and thus additional core material can be saved. This reduces the mass of the rotor blade, which further reduces the mechanical stress. The reduced mechanical stresses are expressed in particular as reduced bending torque at the blade root. Because of the small blade depth in the outer longitudinal section it is also possible to operate the rotor blade with a higher tip speed ratio. This can reduce the strain on the drive train in the partial load range.

In embodiments of the invention, the blade depth in the outer longitudinal section lies in the range from 22% to 30%, or the range from 22% to 28% of the maximum blade depth. Thus, the outer longitudinal section has a more uniform blade depth profile. In this way the advantages of the invention that have been described are achieved to an even greater extent.

In further embodiments, the outer longitudinal section extends over a length of 25% or more of the blade length or a length of 28% or more of the blade length. Again, this may enhance the described advantageous effects.

In one embodiment, the relative blade thickness varies in the vicinity of the outer longitudinal section and is greater at the blade root end of the outer longitudinal section than at the blade tip end of the outer longitudinal section. The relative blade thickness is the ratio of blade thickness and blade depth. In conventional rotor blades, the relative blade thickness in an external region is generally substantially constant and is often about 18%. With the invention, the relative blade thickness increases towards the blade root end of the outer longitudinal section, with an approximately constant blade depth. Compared to a conventional rotor blade, a greater relative blade thickness is achieved by reducing the blade depth in the outer longitudinal section towards the outer blade root end of the longitudinal section, despite an approximately constant absolute blade thickness. Thus, the height of a flexural torsion box, which imparts strength to the wind turbine rotor blade, need not be reduced or need not be reduced by much compared to a conventional wind turbine rotor blade. Sufficient strength can thus be achieved without making radical structural changes to the supporting structure of the wind turbine rotor blade.

In one embodiment, the relative blade thickness at the blade root end of the outer longitudinal section is greater by 10% or more than at the blade tip end of the outer longitudinal section. Experiments have shown that even a 10% or more, for example 30%, greater relative thickness does not significantly reduce the aerodynamic performance of the blade. The described positive effects on the achievable strength of the rotor blade therefore predominate.

In one embodiment, the blade depth decreases in a middle longitudinal section, which extends over 30% or less of the blade length, from 80% or more of the maximum blade depth to 40% or less of the maximum blade depth. The middle longitudinal section is at a distance from both the blade root and from the blade tip. The distance of the middle longitudinal section from the blade root can be, for example, 20% or more, preferably 30% or more of the blade length. The distance of the middle longitudinal section from the blade tip can be, for example, 20% or more, 30% or more or 40% or more of the blade length. In the middle longitudinal section there is a relatively rapid change of the blade depth compared with the blade depth profile of conventional rotor blades. This rapid transition means that the relatively narrow rotor blade in the outer longitudinal section changes within a relatively short longitudinal section into a relatively broad, inner longitudinal section. This relatively abrupt transition differs from the conventional blade depth profile and leads to the total available blade area turning out not to be smaller or not to be significantly smaller than for a conventional rotor blade, despite the relatively narrow outer longitudinal section. The relatively large blade depth at the blade root end of the middle longitudinal section and the adjacent inner connecting region of the rotor blade has a positive effect on the input power; it increases the mechanical stresses that occur, but only relatively slightly. Experiments have shown that the described rapid transition of the blade depth further assisted in achieving an optimum compromise between power consumption and stress.

Furthermore, experiments have shown that the above-mentioned object is also achieved by a wind turbine rotor blade with a blade root, a blade tip and a blade depth varying along the length of the rotor blade which reaches a maximum blade depth at a longitudinal position between the blade root and the blade tip, wherein the blade depth decreases from 80% or more of the maximum blade depth to 40% or less of the maximum blade depth in a middle longitudinal section, which extends over 30% or less of the blade length. This combination of characteristics is therefore also useful regardless of the particular design of the outer longitudinal section.

In further embodiments, the blade depth decreases in the middle longitudinal section from 80% or more of the maximum blade depth to 40% or less of the maximum blade depth and/or the blade depth decreases in the middle longitudinal section to 35% or less of the maximum blade depth and/or the blade depth decreases in the middle longitudinal section to 30% or less of the maximum blade depth. In further embodiments, the middle longitudinal section extends over 25% or less of the blade length or over 20% or less of the blade length. All these embodiments can increase the described positive effects of the relatively rapid transition of the blade depth in the middle longitudinal section.

In one embodiment, the blade depth in an inner longitudinal section, which extends over 20% or more of the blade length, is greater than 88% of the maximum blade depth. In other words the blade depth in the inner longitudinal section is relatively large throughout and is essentially constant in comparison with conventional rotor blades. Thus, the power input in the inner longitudinal section is improved without having to substantially increase the absolute blade depth for this purpose. The fact that the longitudinal section is an inner longitudinal section means that the longitudinal section is located at a relatively large distance from the blade tip. This may, for example, be 50% or more, 60% or more or 70% or more of the blade length.

Experiments have shown that this embodiment, that is, the said blade depth in the inner longitudinal section, is also useful regardless of the described embodiment of an outer and/or middle longitudinal section and is suitable for achieving the object described above. The object is thus also achieved by a wind turbine rotor blade with a blade root, a blade tip and a blade depth varying along the length of the rotor blade, which reaches a maximum blade depth at a longitudinal position between the blade root and the blade tip, wherein the blade depth in an inner longitudinal section of the rotor blade, which extends over 20% or more of the blade length, is greater than 88% of the maximum blade depth.

In one embodiment, the outer longitudinal section, the middle longitudinal section and/or the inner longitudinal section do not overlap. The stated longitudinal sections can also be directly connected to each other or can be located at a distance from each other. The rotor blade is thus clearly divided into several longitudinal sections, each of which has a certain function.

### BRIEF DESCRIPTION OF THE DRAWINGS

The invention will now be described with reference to the drawings wherein:

FIG. 1 shows a rotor blade according to the invention in plan view on the pressure side;

FIG. 2 shows a conventional rotor blade in plan view on the pressure side; and,

FIG. 3 shows a graph of the blade depth profile plotted as a function of the normalized distance from a rotor axis.

### DESCRIPTION OF THE PREFERRED EMBODIMENTS OF THE INVENTION

The wind turbine rotor blade 10 shown in FIG. 1 comprises a blade root 12 and a blade tip 14. At the blade root 12, the wind turbine rotor blade 10 has an essentially circular cross section and is configured for attachment to a rotor hub which is not shown. For example, for this purpose it comprises a flange that is also not shown in the figure. The circular cross section at the blade root 12 transitions into an aerodynamic profile with increasing distance from the blade root 12.

The rotor blade has a maximum blade depth 18 at a first longitudinal position 16. In the embodiment shown, this amounts to approximately 3.3 m. The blade length 20 of the rotor blade shown is approximately 42 m.

Furthermore, FIG. 1 shows an outer longitudinal section 22, a middle longitudinal section 24 and an inner longitudinal section 26. The outer longitudinal section 22 extends over 20% or more of the blade length 20. The blade depth is in the range from 20% to 30% of the maximum blade depth 18 throughout this outer longitudinal section 22.

The middle longitudinal section 24 extends over 30% or less of the blade length 20. In this middle longitudinal section 24, the blade depth decreases from 80% or more of the maximum blade depth 18 at the blade root end of the middle longitudinal section 24 to 40% or less of the maximum blade depth 18 at the blade tip end of the middle longitudinal section 24.

The inner longitudinal section 26 extends over 20% or more of the blade length 20. In this inner longitudinal section 26, the blade depth is greater than 88% of the maximum blade depth 18 throughout.

The outer longitudinal section 22, the middle longitudinal section 24 and the inner longitudinal section 26 do not overlap and are at a distance from each other in the example.

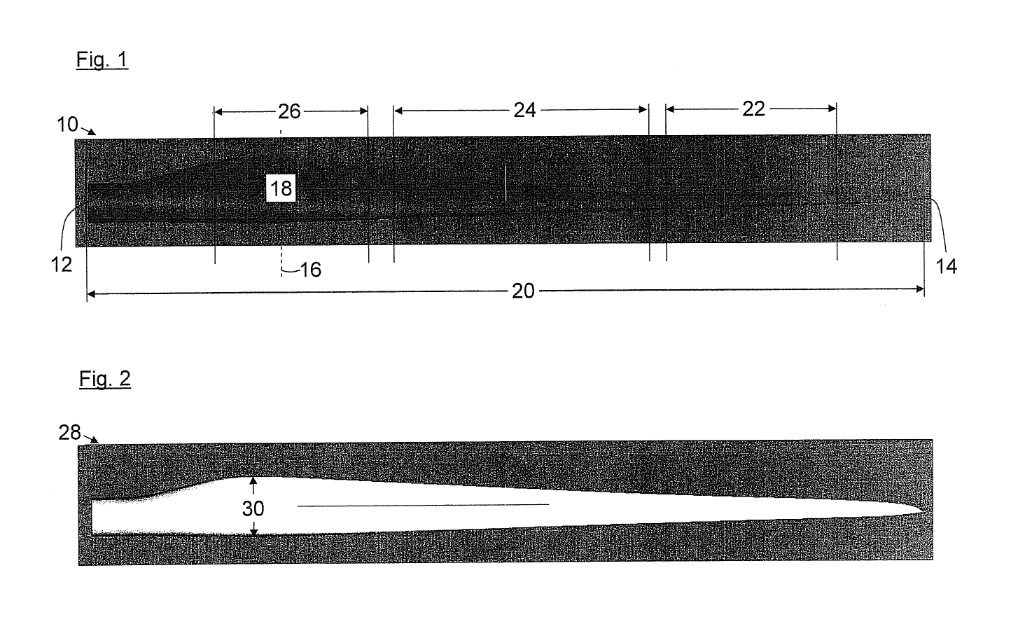

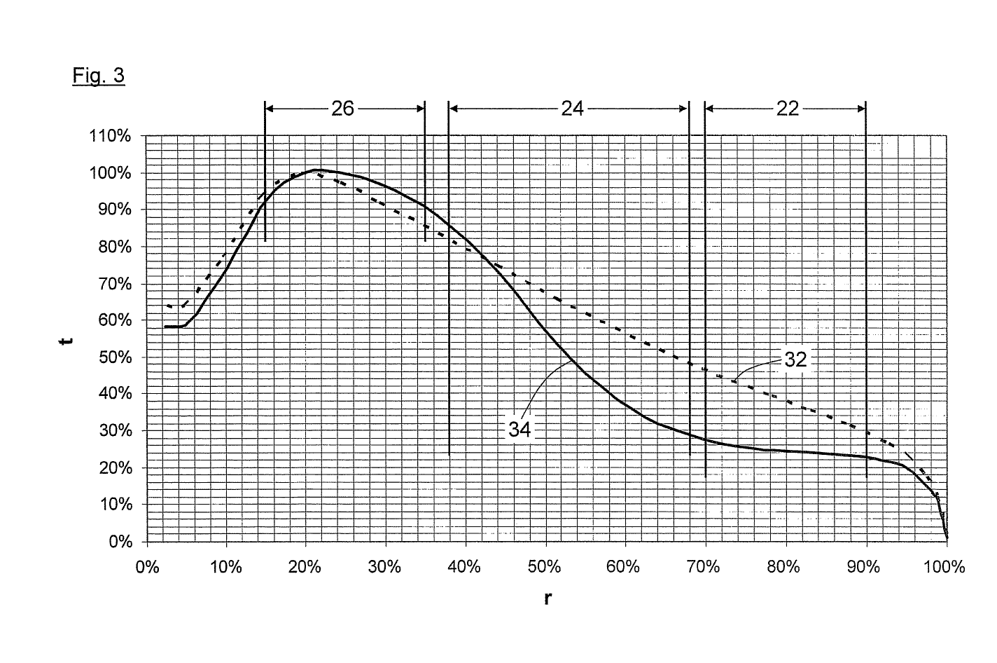

FIG. 2 shows a conventional wind turbine rotor blade 28, which formed the starting point for the invention, in a view corresponding to FIG. 1. The direct comparison shows that the maximum blade depth 30 is lower than the maximum blade depth 18 of the wind turbine rotor blade 10 in accordance with the invention. The maximum blade depth 30 is approximately 3 m. From the comparison of FIGS. 1 and 2, it is also apparent that the outer longitudinal section 22 of the wind turbine rotor blade 10 in accordance with the invention has a lower and less markedly varying blade depth than a corresponding longitudinal section of a conventional wind turbine rotor blade 28. In the middle longitudinal section 24 of the wind turbine rotor blade 10 in accordance with the invention, the blade depth decreases towards the blade tip 14 significantly more rapidly than in a comparable longitudinal section of the conventional wind turbine rotor blade 28.

It is also evident that the inner longitudinal section 26 of the wind turbine rotor blade 10 according to the invention has a more uniform and greater blade depth than a comparably arranged longitudinal section of the conventional wind turbine rotor blade 28.

In FIG. 3 the relative blade depth (t) is plotted against the radius (r), that is, as the dashed curve 32 for the conventional wind turbine rotor blade 28 from FIG. 2 and as the solid curve 34 for the wind turbine rotor blade 10 according to the invention from FIG. 1. The blade depth is shown normalized to 100%, that is, for the curve 32 relative to the maximum blade depth 30 of the wind turbine rotor blade 28 and for the curve 34 relative to the maximum blade depth 18 of the wind turbine rotor blade 10. The corresponding longitudinal position along the blade length is plotted on the x-axis, that is, relative to the distance from a rotor axis and normalized. 100% corresponds to the radial position of the corresponding blade tip. Since the blade root 12 of the wind turbine rotor blade 28 is at a relatively short distance of approximately 1 m from the rotor axis, the percentage scale of the x-axis corresponds essentially to the percentage position relative to 100% of the blade length.

The positions of the three longitudinal sections 22, 24 and 26 are shown in FIG. 3. The outer longitudinal section 22 extends from a radial position of about 70% of the blade length to a radial position of about 90% of the blade length. Within this outer longitudinal section 22, the blade depth decreases from a value of 28% to a value of 22%.

The middle longitudinal section 24 extends from a radius position of 38% to a radius position of 68%. Within this middle longitudinal section 24, the blade depth decreases from a value of approximately 85% to a value of less than 30%.

The inner longitudinal section 26 extends from a radius position of approximately 15% to a radius position of about 35%. Within this inner longitudinal section 26, the blade depth is constantly more than approximately 90% of the maximum blade depth.

A comparison of the two curves 32 and 34 shows that the rotor blade 10 according to the invention has a greater and more uniform blade depth in the inner longitudinal section 26. In the middle longitudinal section 24 there is a more rapid transition from a greater blade depth to a significantly smaller blade depth. In the outer longitudinal section 22 the blade depth is significantly smaller than in the conventional rotor blade and only varies slightly.

Because of the normalization to a blade depth of 100%, it is not clear in the figure that the maximum blade depth 18 of the wind turbine rotor blade 10 is approximately 10% greater than the maximum blade depth 30 of the wind turbine rotor blade 28. This results in the total area of the two wind turbine rotor blades 10 and 28 being essentially of equal size. Also contributing to this is the fact that the wind turbine rotor blade 10 is greater in length by about 2 m than the wind turbine rotor blade 28. This can also not be seen in FIG. 3 because the blade length or the maximum radius of the two wind turbine rotor blades (10, 28) is normalized to 100%.

It is understood that the foregoing description is that of the preferred embodiments of the invention and that various changes and modifications may be made thereto without departing from the spirit and scope of the invention as defined in the appended claims.

### LIST OF THE TERMS USED

10 wind turbine rotor blade
12 blade root
14 blade tip
16 longitudinal position
18 maximum blade depth
20 blade length
22 outer longitudinal section
24 middle longitudinal section
26 inner longitudinal section
28 conventional wind turbine rotor blade
30 maximum blade depth
32 dashed curve
34 solid curve

What is claimed is:

1. A wind turbine rotor blade comprising:
a blade root;
a blade tip;
said rotor blade having a blade length and a blade depth which varies over said length thereof;
said blade depth reaching a maximum blade depth at a longitudinal position along said length between said root and said tip;
an outer longitudinal section extending over 20% or more of said blade length; and,
said rotor blade having a blade depth in said outer longitudinal section which lies in a range of 20% to 30% of said maximum blade depth.

2. The wind turbine rotor blade of claim 1, wherein said blade depth in said outer longitudinal section lies in a range of 22% to 30% of said maximum blade depth.

3. The wind turbine rotor blade of claim 1, wherein said blade depth in said outer longitudinal section lies in a range of 22% to 28% of said maximum blade depth.

4. The wind turbine rotor blade of claim 1, wherein said outer longitudinal section extends over 25% or more of said blade length.

5. The wind turbine rotor blade of claim 1, wherein said outer longitudinal section extends over 28% or more of said blade length.

6. The wind turbine rotor blade of claim 1, wherein said outer longitudinal section has a first end facing toward said blade root and a second end facing toward said blade tip; said rotor blade has a relative blade thickness in said outer section which varies; and, said relative blade thickness is greater in the area of said first end facing toward said blade root than in the area of said second end facing toward said blade tip.

7. The wind turbine rotor blade of claim 6, wherein said rotor blade has a relative blade thickness at said first end facing toward said blade root at least 10% greater than at said second end facing toward said blade tip.

8. The wind turbine rotor blade of claim 1, further comprising:
a middle longitudinal section which extends over 30% or less of said blade length; and,
said rotor blade having a blade depth in said middle longitudinal section which decreases from 80% or more of said maximum blade depth to 40% or less of said maximum blade depth.

9. The wind turbine rotor blade of claim 1, further comprising:
a middle longitudinal section which extends over 30% or less of said blade length; and,
said rotor blade having a blade depth in said middle longitudinal section which decreases from 85% or more of said maximum blade depth to 40% or less of said maximum blade depth.

10. The wind turbine rotor blade of claim 1, further comprising:
a middle longitudinal section which extends over 30% or less of said blade length; and,
said rotor blade having a blade depth in said middle longitudinal section which decreases to 35% or less of said maximum blade depth.

11. The wind turbine rotor blade of claim 1, further comprising:
a middle longitudinal section which extends over 30% or less of said blade length; and,
said rotor blade having a blade depth in said middle longitudinal section which decreases to 30% or less of said maximum blade depth.

12. The wind turbine rotor blade of claim 8, wherein said middle longitudinal section extends over 25% or less of said blade length.

13. The wind turbine rotor blade of claim 8, wherein said middle longitudinal section extends over 20% or less of said blade length.

14. The wind turbine rotor blade of claim 1, further comprising an inner longitudinal section which extends over 20% or more of said blade length and said rotor blade having a blade depth in said inner longitudinal section which is greater than 88% of said maximum blade depth.

15. The wind turbine rotor blade of claim 1, further comprising:
an inner longitudinal section which extends over 20% or more of said blade length and said rotor blade having a blade depth in said inner longitudinal section of 88% or more of said maximum blade depth;
a middle longitudinal section which extends over 30% or less of said blade length;
said rotor blade having a blade depth which decreases from 80% or more of said maximum blade depth to 40% or less of said maximum blade depth; and,
said outer longitudinal section, said middle longitudinal section and said inner longitudinal section being arranged along said length so as to cause each two mutually adjacent ones of said longitudinal sections to not overlap each other.
